(19) United States
(12) Patent Application Publication
(10) Pub. No.: US 2014/0141287 A1
(43) Pub. Date: May 22, 2014

(54) BATTERY PACK AND BATTERY CONTROL MODULE

(71) Applicant: DELPHI TECHNOLOGIES, INC., Troy, MI (US)

(72) Inventors: JOSEPH A. BERTUCCI, FARMINGTON HILLS, MI (US); DANIEL S. EICHORN, ROCHESTER HILLS, MI (US); ROBERT C. BEER, NOBLESVILLE, IN (US); JOHN V. CAPUTO, CANFIELD, OH (US)

(73) Assignee: DELPHI TECHNOLOGIES, INC., TROY, MI (US)

(21) Appl. No.: 13/680,720

(22) Filed: Nov. 19, 2012

(51) Int. Cl. H01M 10/42

(52) U.S. Cl. CPC H01M 10/425
USPC 429/7; 361/679.01; 361/752

(57) ABSTRACT

A battery pack containing a plurality of battery cells having a housing and defining an opening within the housing and a battery control module configured to be disposed within the opening of the battery pack. The battery control module may contain circuitry for controlling a connection between the battery pack and an electric load or electric source and for controlling the charging of the battery cells. The circuitry within the battery control module is connected by rigid conductors, such as conductive traces on a circuit board or bus bars rather than flexible wire cables. The battery control module may be configured to be removed for serving the battery pack without removing the battery pack housing. The battery pack may further include a battery voltage monitor configured to monitor a terminal voltage of each battery cell and send a digital signal representing the voltage to the battery control module.

### TECHNICAL FIELD OF INVENTION

The invention generally relates to a battery control module for a battery pack, particularly for a battery pack having a housing that defines an opening.

### BACKGROUND OF INVENTION

Battery packs have been used to supply electrical power for electric vehicles and back-up power supplies. The battery packs typically include a plurality of battery cells that may be in series or in parallel connection in order to provide a desired voltage or current capacity. The battery cells are typically assembled into battery packs that are contained within a housing that is configured to provide electrical shielding for the battery cells to prevent accidental contact with a terminal of a battery cell that could cause undesirable or harmful electric currents. The battery cells may also be assembled into subassemblies sometimes referred to as battery modules and the battery modules are assembled into the battery pack. The housing may also be configured to provide electromagnetic shielding to prevent electromagnetic interference (EMI) that may be generated when the battery cells are charging or discharging electrical current from interfering with other electrical devices and may also provide environmental shielding to prevent dirt, moisture, or other environmental contaminants from contacting the battery cells. The battery pack typically has connectors connected to an electrical load, such as an electric motor, disposed on the outside of the housing by flexible wire cables via an opening in the housing.

The battery pack typically includes electronic circuitry to control the connection between the electrical load and the plurality of battery cells. The battery pack also typically includes electronic circuitry to control the recharging of the battery cells when the battery pack is connected to an electrical power source, such as an electrical generator. The circuitry for controlling the connection and battery charging are typically located within the battery pack housing in order to take advantage of the electrical, environmental, and EMI shielding provided by the housing. The battery connection circuitry and the battery charging circuitry may be separate electronic assemblies that are interconnected to each other and to the battery cell terminals and load connector by separate flexible wire cables. If the battery connection circuitry or battery charging circuitry needs to be repaired while the battery pack is in service, it may be necessary to remove the entire housing in order to gain access to the battery connection circuitry or the battery charging circuitry.

### SUMMARY OF THE INVENTION

The inventors recognized the problem of allocating packaging space to accommodate a number of separate flexible wire cables to interconnect the battery connection circuitry and battery charging circuitry within the housing. The inventors also recognized the problems presented by removing the housing from the battery pack in order to access to the battery connection circuitry and battery charging circuitry in order to gain access to the circuitry.

Described herein are solutions for interconnecting battery connection circuitry and battery charging circuitry without the use of flexible wire cables and for accessing the battery charging circuitry and battery connection circuitry without the need to remove the housing from the battery pack.

In accordance with one embodiment of this invention, a battery control module configured for use with a battery pack having a housing that defines an opening is provided. The battery control module includes a cover that is configured to be disposed within the opening. The cover can be attached to the battery pack to close the opening. The battery control module also includes a plurality of rigid conductors disposed on the cover. The battery control module further includes a first connector disposed on an outer surface of the cover. The first connector is coupled to the plurality of rigid conductors and can be connected to an electrical load. The battery control module includes a battery connector coupled to the plurality of rigid conductors and to the first connector. The battery connector can be connected to a battery cell located within the housing. The battery control module additionally includes a controller disposed on the inner surface of the cover. The controller is coupled to the plurality of rigid conductors. The battery control module also includes a battery connection circuit disposed on the cover. The battery connection circuitry is coupled to the plurality of rigid conductors and is in communication with the controller. The battery connection circuitry establishes or breaks an electrical connection between the battery pack and the electrical load in response to a signal from the controller.

A first portion of the plurality of rigid conductors may be conductive traces on a printed circuit board. A second portion of the plurality of rigid conductors may be bus bars. The bus bars may be disposed within a carrier constructed of a dielectric material.

The battery control module may further include a fusible link between the first connector and the battery connector. The fusible link may be a replaceable device.

The cover may define a service access portal configured to allow a user to access a replaceable device disposed on the cover. The battery control module may further include an access lid configured to enclose the service access portal when closed and configured to allow access to the replaceable device when opened and a detection device configured to determine whether the access lid is opened or closed. The detection device may be in communication with the controller. The controller may be configured to control the battery connection circuitry based on whether the access lid is opened or closed. The access lid may be configured to provide both environmental sealing and electrical shielding.

The cover may provide environmental sealing for the opening and/or electrical shielding for the housing.

The controller may include circuitry to determine a terminal voltage of the battery pack. The controller may also include circuitry to receive and interpret a plurality of digital signals indicative of the terminal voltage of the battery cells and groups of battery cells that make up a battery module. The controller may also include circuitry to determine the current provided by the battery pack.

The battery control module may further include a third connector coupled to the controller to connect to a vehicle communication bus, whereby the controller may transmit the plurality of digital signals.

In another embodiment of the present invention, a battery pack that interfaces with an electrical load and electrical source is provided. The battery pack includes a plurality of battery cells and a housing configured to contain the plurality of battery cells. The housing defines an access opening and a battery control module is disposed within the access opening.

The battery pack may further include a battery voltage monitor configured to determine a terminal voltage of each battery cell or groups of battery cells in a portion of the plurality of battery cells. The battery voltage monitor may be configured to transmit a plurality of digital signals indicative of the terminal voltage of each battery cell or groups of battery cells in the plurality of battery cells. The battery voltage monitor may be in communication with the controller. The controller may be configured to receive and interpret the plurality of digital signals.

The battery pack may further include an intermodule connector that is configured to electrically couple a first terminal of a first battery cell in the plurality of battery cells to a second terminal of a second battery cell in the plurality of battery cells. The intermodule connector may be coupled to the battery voltage monitor. The battery pack may also include an intermodule connector holder that is configured to mechanically couple the intermodule connector to the first battery cell and the second battery cell. The intermodule connector holder may be configured to electrically isolate the intermodule connector from the first terminal and the second terminal until the intermodule connector is attached to the first terminal and the second terminal.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is an exploded perspective view of a battery pack in accordance with one embodiment;

FIG. 2 is an exploded perspective view of a battery control module in accordance with one embodiment;

FIG. 3 is another exploded perspective view of the battery control module viewed from a different perspective in accordance with one embodiment;

FIG. 4 is perspective view of a battery voltage monitoring circuit in accordance with one embodiment;

FIG. 5 is perspective view of a battery voltage monitor in accordance with another embodiment;

FIG. 6a is a perspective view of a conducive jumper and jumper holder is an un assembled state in accordance with one embodiment;

FIG. 6b is a perspective view of a conductive jumper and a jumper holder in an assembled state in accordance with one embodiment; and

FIG. 7 is a cutaway perspective view of an access lid and secondary access lid configured to enclose an access portal in accordance with one embodiment.

### DETAILED DESCRIPTION OF INVENTION

A battery pack including a battery control module that is disposed within an opening in a housing of the battery pack is described. The battery control module incorporates battery connection circuitry and battery charging circuitry into a single assembly that eliminates the need for separate flexible wire cables to connect the battery connection circuitry and battery charging circuitry.

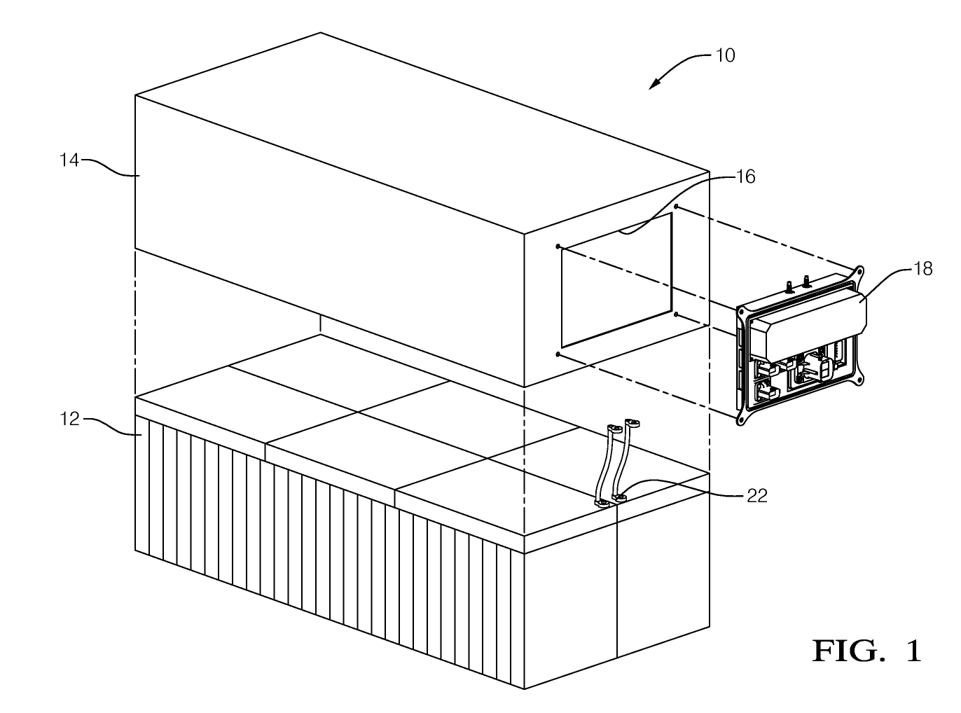

FIG. 1 illustrates a non-limiting example of a battery pack 10 that interfaces with an electrical load, such as an electric motor and may be configured to interface with an electrical source, such as an electrical generator. The battery pack 10 may be used in an electrically powered vehicle or in a back-up electrical power supply system. The battery pack 10 may also be connected to an electrical power source, such as an electrical generator, in order to recharge a plurality of battery cells contained within the battery pack 10. The battery pack 10 includes a housing 14 that contains a plurality of battery cells. Each battery module may be made up of a plurality of individual battery cells using battery chemistries such as lead-acid, Nickel Metal Hydride (NiMH), or Lithium Ion (Li ion). Suitable battery cells or battery modules may be available from a number of sources, such as Johnson Controls of Plymouth, Mich. or Dow Kokam of Midland, Mich. The battery cells may be interconnected in series so that the battery pack 10 may provide a higher voltage than an individual battery cell and the battery cells may be connected in parallel so that the battery pack 10 may provide a larger current than an individual battery cell.

The housing 14 is configured to provide electrical shielding for the battery cells to prevent accidental contact with a terminal of a battery cell that could cause undesirable electric currents. The housing 14 may also provide electromagnetic shielding to prevent electromagnetic interference (EMI) that may be generated when the battery cells are charging or discharging electrical current from interfering with other electrical devices. The housing 14 may also provide environmental shielding to prevent dirt, moisture, or other environmental contaminants from contacting the battery cells. The housing 14 may be constructed of a laminated material with conductive and dielectric layers to provide both electrical and electromagnetic shielding. Alternatively, the housing 14 may be constructed of a plastic composite material. An example of a battery pack housing constructed of a plastic composite material is described in US Patent Application 2012/0103714 entitled BATTERY PACK HOUSING ASSEMBLY FOR ELECTRIC VEHICLE USING PLASTIC COMPOSITE MATERIAL filed Mar. 3, 2011. The housing 14 defines an opening 16 that allows access to the interior of the housing 14 and a battery control module 18 is disposed within the opening 16. The opening 16 may preferably be located on a portion of the housing 14 that may be accessible for servicing the battery pack 10 when the battery pack 10 is installed in its intended service location. The opening 16 may provide access to wire cables 20 that are connected to a plurality of battery terminals 22 of the plurality of battery cells. The wire cables 20 may connect the battery control module 18 to the plurality of battery terminals 22.

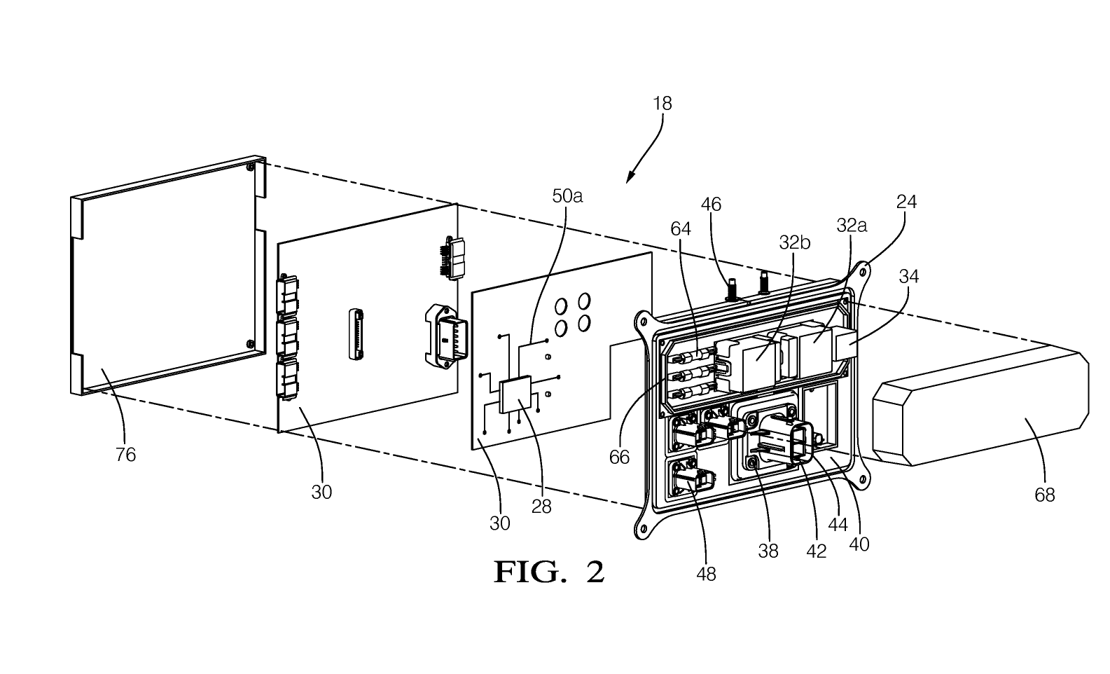

FIG. 2 illustrates a non-limiting example of a battery control module 18 for use with a battery pack 10 having a housing 14 that defines an opening 16. The battery control module 18 may control a connection between the plurality of battery cells and an electrical load in order to prevent high currents during initial connection of the battery pack 10 to the electrical load and to disconnect the battery pack 10 from the electrical load if an electrical fault is detected. The battery control module 18 may also monitor the voltages of at least a portion of the battery cells in the plurality of battery cells and control the charging rate of the battery cells based at least on those voltages.

The battery control module 18 includes a cover 24 that is disposed within the opening 16 defined by the battery pack 10 housing 14. The cover 24 also attaches to the housing 14 to enclose the opening 16. The cover 24 may include a compliant gasket to provide environmental sealing for the opening 16. The cover 24 may be constructed of a conductive material, such as die cast aluminum and may be attached to the housing 14 by conductive fasteners in order to provide electrical shielding for the housing 14.

The battery control module 18 additionally includes battery connection circuitry and battery charging circuitry. This circuitry includes a controller 28 disposed on the cover 24. The controller 28 is configured to control an electrical connection between the battery pack 10 and the electrical load and may be used to control charging of at least one battery cell of the plurality of battery cells. The controller 28 may also serve to determine a temperature of the plurality of battery cells and to control a thermal management system, such as a cooling fan or liquid coolant circuit, to control the temperature of the plurality of battery cells. The controller 28 may also be adapted to disconnect the plurality of battery cells from an electrical load or electrical source if the temperature exceeds a temperature threshold.

The controller 28 may include a microprocessor or application specific integrated circuit (ASIC). Software that programs the microprocessor or ASIC to control the electrical connection circuitry and to control the battery charging circuitry may be stored in non-volatile (NV) memory within the controller 28. Non-limiting examples of the types of NV memory that may be used include electrically erasable programmable read only memory (EEPROM), masked read only memory (ROM) and flash memory. The controller 28 may also include analog to digital (A/D) convertor circuits and digital to analog (D/A) convertor circuits to allow the convertor to establish electrical communication with devices outside the controller 28, such as sensors. The controller 28 may also include power supply circuitry. The controller 28 may be disposed on a circuit board 30 that is disposed on the cover 24. The design of and construction methods for controllers are well known to those skilled in the art.

The battery connection circuitry is disposed on the cover 24. The battery connection circuitry may include a primary contactor 32 that may be characterized as a high current relay or high current solid state device, such as a metal-oxide-semiconductor field-effect transistor (MOSFET), which establishes an electrical connection between at least one of the battery cells in the plurality of battery cells included within the battery pack 10 and the electrical load or electrical source. The battery connection circuitry may include a pair of primary contactors, one controlling the connection between a negative terminal of at least one of the battery cells in the plurality of battery cells included within the battery pack 10 and a negative terminal of the electrical load 32a and another controlling the connection between a positive terminal of at least one of the battery cells in the plurality of battery cells included within the battery pack 10 and a positive terminal of the electrical load 32b. The battery connection circuitry may also include a pre-charge contactor 34 that includes a pre-charge resistor that is configured to limit an in-rush current that may be caused by the initial charging of capacitive devices within and connected to the battery control module 18 during an initial connection time. The battery connection circuitry is in communication with the controller 28. The battery connection circuitry establishes or breaks the electrical connection between at least one of the battery cells in the plurality of battery cells included within the battery pack 10 and the electrical load in response to a signal from the controller 28. The controller 28 may determine whether the battery connection circuitry makes or breaks the electrical connection based on a signal from a vehicle motor controller 28, a ground fault sensor, or another controller 28 or sensor. The battery connection circuitry may include removable or replaceable components, such as relays.

The battery control module 18 further includes a load connector 38 disposed on an outer surface 40 of the cover 24. As used herein, the outer surface 40 of the cover 24 is outside of the battery pack 10 housing 14 when the battery control module 18 is installed within the opening 16. The load connector 38 may be characterized as a high voltage, high current connector and connects to an electrical load, such as an electric motor. The load connector 38 may also connect to an electrical source, such as an electric generator. The load connector 38 may include a plurality of conductive terminals 42 that conduct a high voltage signal. The load connector 38 may also include a load connector body 44 constructed of a dielectric material to provide mechanical support and electrical insulation to the plurality of conductive terminals 42.

The battery control module 18 also includes a battery connector 46 that is disposed on an inner surface 41 of the cover 24 coupled to at least one of the battery cells in the plurality of battery cells. As used herein, the inner surface 41 of the cover 24 is inside of the battery pack 10 housing 14 when the battery control module 18 is installed within the opening 16. The battery connector 46 is also coupled to the load connector 38 via the battery connection circuitry. The plurality of battery cells may be electrically coupled to an electric load via the load connector 38 and battery connector 46 in order to provide electric power to the electric load. The plurality of battery cells may also be connected to an electrical source via the load connector 38 and battery connector 46 in order to provide electrical power to recharge the battery cells. According to the embodiment illustrated in FIG. 2, the battery connector 46 may include a plurality of threaded studs that conduct a high voltage signal and connect to a ring terminal of a wire cable attached to a battery cell terminal.

The battery control module 18 may also include an auxiliary connector 48 that may be characterized as a high voltage, low current connector. The auxiliary connector 48 may provide a high voltage power supply to auxiliary systems such as an air conditioning compressor motor, a heating element, or a power steering motor in an electric or hybrid electric vehicle.

The battery control module 18 also includes a plurality of rigid conductors 50 disposed on the cover 24. The rigid conductors 50 may electrically couple the controller 28, battery connection circuitry, connectors, and other electrical components included in the battery control module 18. As used herein, the rigid conductors 50 are not flexible under the normal operating and environmental conditions of the battery control module 18. The rigid conductors 50 are explicitly not braided wire or flexible solid wire conductors.

As illustrated in FIG. 2, a first portion of the plurality of rigid conductors 50a may be characterized as conductive traces 50a disposed on a circuit board 30. The conductive traces 50a may electrically couple components of the battery control module 18, such as the controller 28, primary contactor 32, load connector 38, battery connector 46, and auxiliary connector 48. The conductive traces 50a may be disposed on the circuit board 30 by a metallic plating process or by printing a conductive ink on the circuit board 30. The circuit board 30 may be made from epoxy or polyimide resins. The resin may be reinforced with a woven glass cloth or other matrix such as chopped fibers. Circuit boards formed of such materials are typically called FR-4 or G-10 type circuit boards. The circuit board 30 may alternately be constructed of ceramic or rigid polymers. The layout of the conductive traces 50a must account for the placement of high voltage circuits in order to provide sufficient voltage creepage and voltage clearance distances between conductive traces 50a. The materials and manufacturing processes used to construct printed circuit boards are well known to those skilled in the art. This listing of acceptable circuit board materials and construction processes are not exhaustive and other materials and construction processes may also be used successfully.

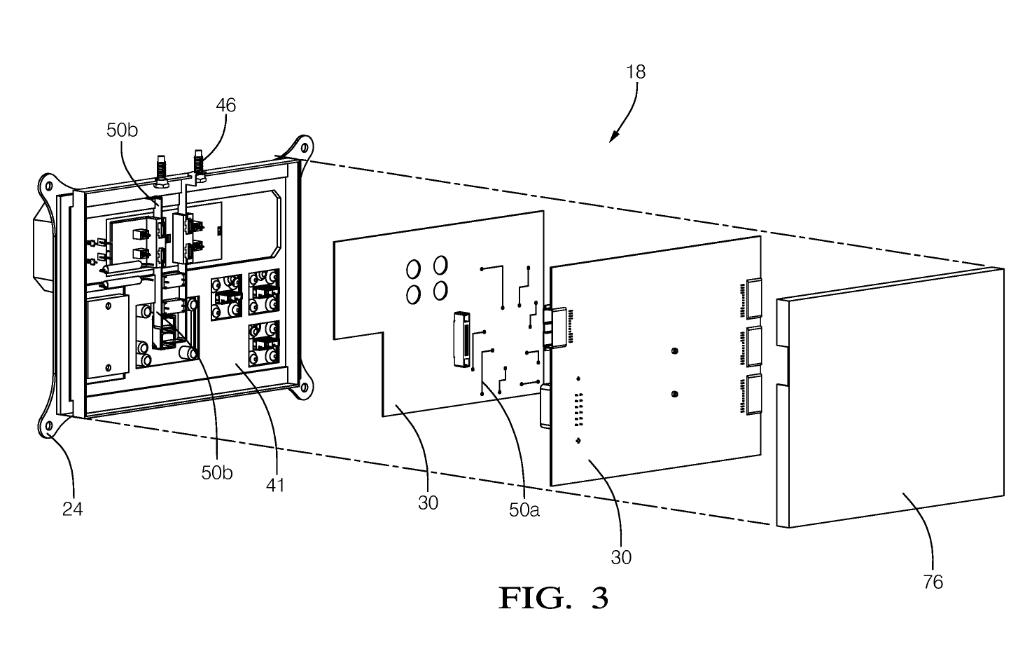

As illustrated in FIG. 3, a second portion of the plurality of rigid conductors 50b may be characterized as bus bars 50b. As used herein, a bus bar is a rigid conductor formed of a material having high conductivity, as a non-limiting example copper or copper alloy, so as to conduct a high current, for example more than 200 amperes. Because of the challenges of manufacturing conductive traces capable of carrying high current on printed circuit boards, a bus bar may advantageously be used to construct an electrical circuit configured to carry high current. The bus bar may be electrically and mechanically coupled to components such as the primary contactor 32 or load connector 38. The bus bar may also be electrically and mechanically coupled to the conductive traces by soldering the bus bar to the conductive traces. Alternatively, a plurality of bus bars 50b may be disposed within a carrier constructed of a dielectric material and coupled to a printed circuit board 30 by a plurality of compliant receptacles that are configured to receive and secure the bus bar. As a non-limiting example, the carrier may be constructed of a polymer material, such as polyamide (NYLON) or polybutylene terephthalate (PBT). The bus bar may be coated with a conductive material, such as tin, in order to provide corrosion resistance for the bus bar. The bus bars 50b may be advantageously used to form circuits between the battery connector 46 and the primary contactor 32 and the load connector 38 and the primary contactor 32, since these circuits may require a high current capacity.

The battery control module 18 may be constructed so that the first plurality of rigid conductors 50a conducts low voltage signals. As used herein, low voltage signals are less than 45 volts. The battery control module 18 may be further constructed so that the second plurality of rigid conductors 50b conducts high voltage signals. As used herein, high voltage signals are more than or equal to 45 volts.

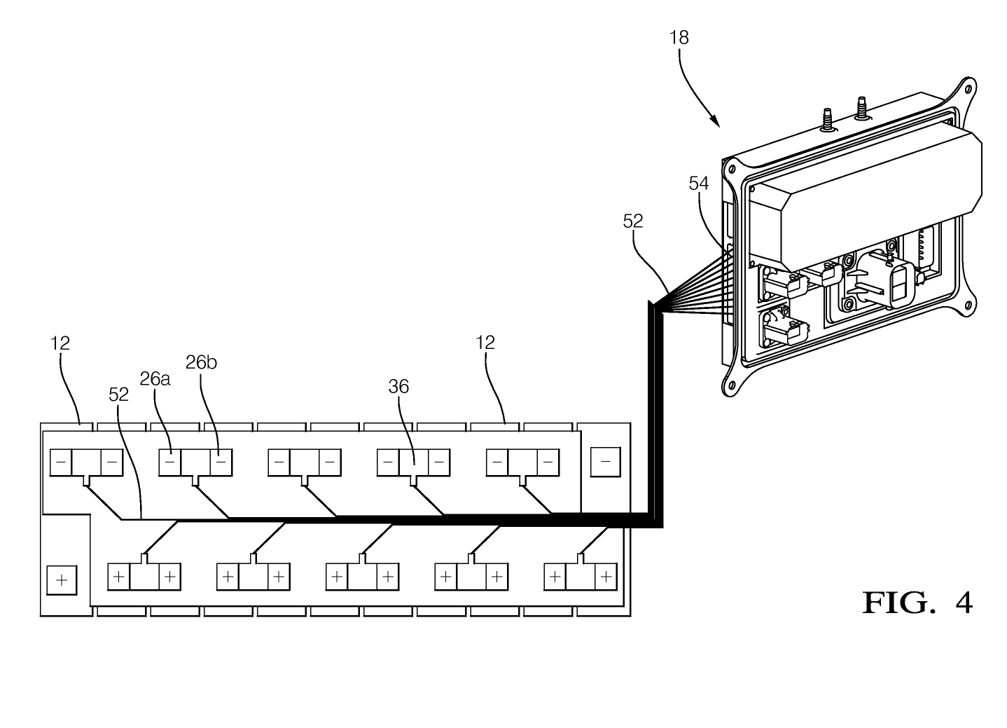

The controller 28 may be designed to determine a terminal voltage of each battery cell in a portion of the plurality of battery cells included within the battery pack 10. According to an embodiment illustrated in FIG. 4, a separate sense wire 52 may be connected from each battery terminal 26 of the plurality of battery terminals 22 to a battery voltage connector 54 on the battery control module 18 and then connected to A/D convertor circuitry within the controller 28. In this non-limiting example, the plurality of battery cells are connected in series by a conductive jumper 56 between pairs of like (positive or negative) battery terminals 26a, 26b in the string of series connected battery cells. Since each connected pair of terminals have the same voltage, a sense wire 52 only needs to be connected to each pair of connected terminals. This embodiment may require a large number of wires within a wiring harness and a large number of terminals in the battery voltage connector 54. This may present component packaging challenges within the battery pack 10 and within the battery control module 18 in order to accommodate the size of the wiring harness and the battery voltage connector 54. In addition, if the battery cells are connected in series in the battery pack 10, there may be large voltage differences between some of the battery terminals that should be considered when determining the routing of the sense wires and placement of terminals in the battery voltage connector 54.

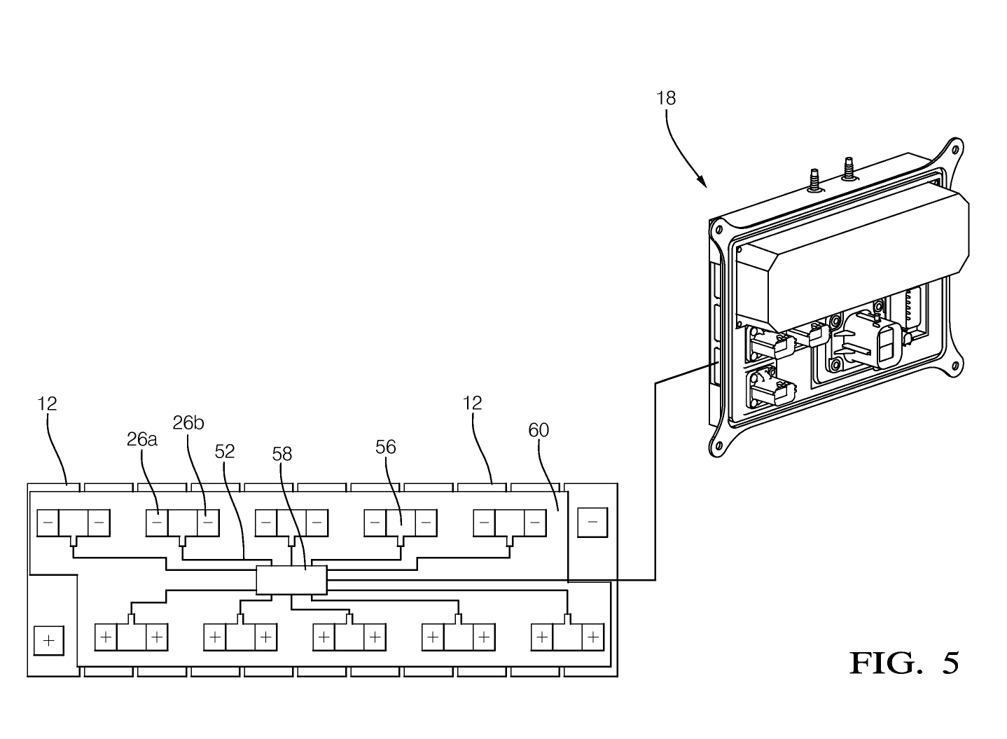

According to another embodiment illustrated in FIG. 5, the battery pack 10 may include a battery voltage monitor 58 that determines a voltage of at least a portion of the terminals of the plurality of battery cells. The battery voltage monitor generates a plurality of digital signals that are indicative of the terminal voltage of each battery cell in the plurality of battery cells and to transmit the plurality of digital signals to the controller 28. The controller 28 may receive and interpret the plurality of digital signals. The battery voltage monitor 58 may be disposed on a battery module. The battery control module 18 may include a controller 28 containing A/D convertor circuitry that is electrically coupled to each terminal in the portion of terminals and may determine the voltage of each terminal in the portion of terminals and generate the plurality of digital signals, such as BQ76PL600 manufactured by Texas Instruments of Dallas, Tex. The conductive jumper 56 may be coupled to the battery voltage monitor 58 by the sense wire 52. The battery voltage monitor 58 may be disposed on a substrate 60 that is itself disposed on the plurality of battery cells.

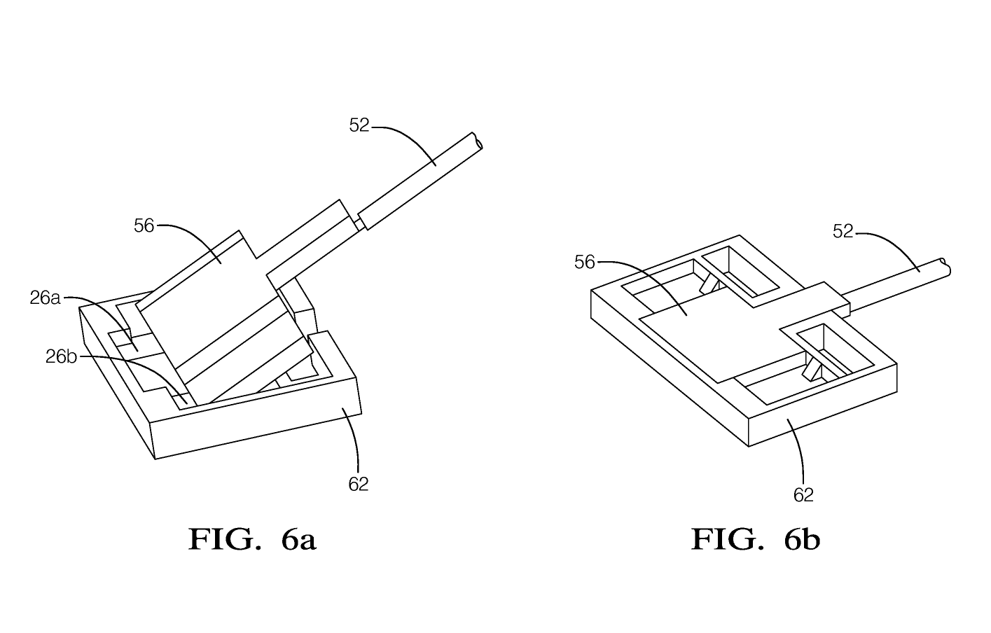

According to another embodiment illustrated in FIGS. 6 and 6b, the battery pack 10 may also include a jumper holder 62 that is configured to mechanically couple the conductive jumper 56 to a first battery terminal 26a and a second battery terminal 26b. According to a non-limiting example illustrated in FIG. 6a, two contact plates extending from a central portion of the jumper may contact a first battery terminal 26a of a first battery cell and a second battery terminal 26b of a second battery cell. The jumper holder 62 may be disposed above the first battery terminal 26a and the second battery terminal 26b and may define an opening allowing access to the first battery terminal 26a and the second battery terminal 26b. The jumper holder 62 may also define a ledge that secures an edge of the conductive jumper 56 when the conductive jumper 56 is inserted into the jumper holder 62. The jumper holder 62 may also define a snap feature that consists of a compliant ramp that will allow the conductive jumper 56 to be inserted into the jumper holder 62 such that the conductive jumper 56 makes contact with the first battery terminal 26a and the second battery terminal 26b. The snap feature may then secure the conductive jumper 56 within the jumper holder 62. The conductive jumper 56 may then be secured to the first battery terminal 26a and the second battery terminal 26b by an attaching facility, such as a threaded fastener or an ultrasonic welding process. The jumper holder 62 may electrically isolate the conductive jumper 56 from the first terminal and the second terminal by delaying contact between the conductive jumper 56 and the first battery terminal 26a and the second battery terminal 26b until the jumper is seated in the jumper holder 62.

Referring once again to FIG. 2, the battery control module 18 may further include a fusible link 64 in a circuit between the load connector 38 and the battery connector 46. The fusible link 64 may be a removable or replaceable device. The fusible link 64 may be used to decouple the plurality of battery cells from the load connector 38 when it is manually removed. This may allow the battery cells to be isolated from the load connector 38 in order to service a vehicle containing the battery pack 10 or to isolate the battery cells in case of an emergency or accident involving the vehicle.

The cover 24 may define a service access portal 66 configured to allow a user or a service technician to access a replaceable device disposed on the cover 24, such as the fusible link 64. The battery control module 18 may further include an access lid 68 configured to enclose the service access portal 66 when closed to allow access to the replaceable device when opened.

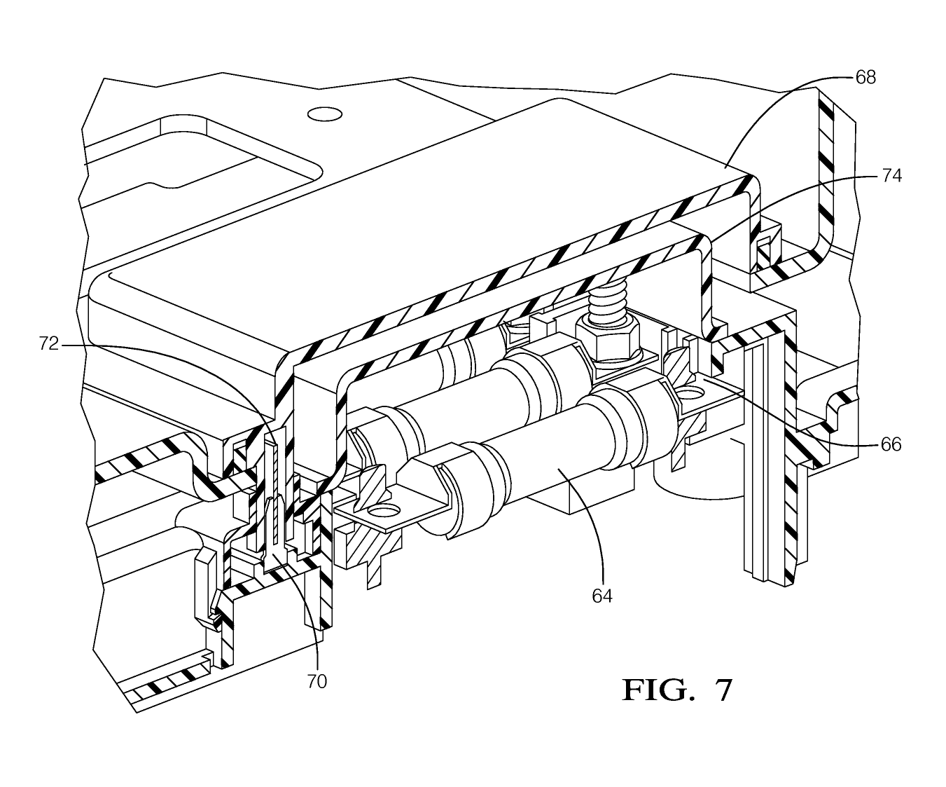

According to another embodiment illustrated in FIG. 7, the battery control module 18 may also include a detection device 70, which may also be referred to as a high voltage interlock (HVIL), that determines whether the access lid 68 is opened or closed. The detection device 70 may comprise a conductive jumper 72 disposed within the access lid 68 that closes a circuit between two terminals when the access lid 68 is closed and open the circuit between the two terminals when the access lid 68 is opened. The terminals may be recessed to help prevent mechanical damage to the terminals. The detection device 70 may alternatively be a contact switch that closes when the access lid 68 is closed and open when the access lid 68 is open or a Hall Effect switch that is configured to detect a magnetic field associated with the access lid 68. The detection device 70 may be in electrical communication with the controller 28. The controller 28 may be designed to control the battery connection circuitry to break the connection when the access lid 68 is opened or establish the connection when the access lid 68 is closed. The controller 28 may be similarly designed to control the battery connection circuitry to break the connection when a mating connector is removed from the load connector 38 or the auxiliary connector 48. The access lid 68 may include a compliant gasket for environmental sealing for the access portal. The access lid 68 may be constructed of metallized plastic or stamped metal to provide electrical shielding for the access portal.

According to a non-limiting example of operation, when the access lid 68 is removed and the detection device 70 detects that the access lid 68 is opened, the controller 28 commands the primary contactors to open while commanding the pre-charge contactor 34 to close until a time threshold is reached so that capacitive devices within and connected to the battery control module 18 may be brought to ground potential by connecting them to ground through the pre-charge resistor. The battery control module 18 may further include a secondary access lid 74 disposed beneath the access lid 68. The secondary access lid 74 may be used to delay access to the replaceable devices until after the time threshold is reached. Access to the replaceable devices via the secondary lid may be delayed by requiring the removal of a plurality of threaded fasteners to secure the secondary access lid 74 before the access portal can be opened, wherein the time required to remove the threaded fasteners after the access lid 68 is opened exceeds the threshold time.

Referring once more to FIG. 2, the battery control module 18 may further include a rear cover 76 that provides electrical shielding to the battery connection circuitry and the battery charging circuitry. The rear cover 76 may define openings for connectors to accommodate connections between the battery control module 18 and the plurality of battery cells. The rear cover 76 may be disposed within the housing 14.

Accordingly, a battery pack 10 and a battery control module 18 are provided. Interconnecting the battery connection circuitry and the battery charging circuitry via rigid conductors 50 within the battery control module 18 provides a compact package due to the elimination of flexible wire cables. Electrically connecting the battery charging circuitry, battery connection circuitry, load connector 38, and battery connector 46 via rigid connectors such as bus bars 50b or circuit board 30 traces rather than separate flexible wire cables may reduce the packaging space required within the battery pack 10 to electrically connect these devices. The battery control module 18 also provides an easily serviceable battery pack 10. Battery connection circuitry components, such as the primary contactor 32 or pre-charge contactor 34 may be accessed for service via the access portal. The entire battery control module 18 may be replaced without removing the battery pack 10 housing 14, since the battery control module 18 may be mounted to the outside of the housing 14 within the opening 16 of the housing 14. The battery control module 18 may also simplify the assembly process for the battery pack 10, since these is no need to separately mount the battery connection circuitry and battery charging circuitry within the housing 14 and electrically couple the battery connection circuitry and battery charging circuitry via separate flexible wire cables.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A battery control module configured for use with a battery pack having a housing that defines an opening, said battery control module comprising:
a cover disposable within said opening and attachable to said battery pack to close said opening;
a plurality of rigid conductors disposed on said cover;
a first connector disposed on an outer surface of the cover, coupled to said plurality of rigid conductors, so as to connect to an electrical load;
a second connector disposed on an inner surface of the cover coupled to said plurality of rigid conductors and to said first connector, said second connector configured to be connected to a battery cell located within the housing;
a controller disposed on said cover, coupled to said plurality of rigid conductors; and
a battery connection circuit disposed on said cover, coupled to said plurality of rigid conductors, and in communication with said controller, wherein said battery connection circuit is configured to establish or break an electrical connection between said battery cell and said electrical load in response to a signal from said controller.

2. The battery control module of claim 1, wherein a first portion of said plurality of rigid conductors are conductive traces on a printed circuit board.

3. The battery control module of claim 2, wherein a second portion of said plurality of rigid conductors are bus bars.

4. The battery control module of claim 3, wherein the bus bars are disposed within a carrier constructed of a dielectric material.

5. The battery control module of claim 1, wherein said battery control module further includes a fusible link between the first connector and the second connector.

6. The battery control module of claim 5, wherein the fusible link is a replaceable device.

7. The battery control module of claim 1, wherein said cover defines a service access portal configured to allow a user to access a replaceable device disposed on the cover, wherein said battery control module further includes,
an access lid sized to enclose the service access portal when closed and configured to allow access to said replaceable device when opened; and
a detection device to determine whether the access lid is opened or closed, said detection device in communication with said controller, wherein said controller controls said battery connection circuit based on whether the access lid is opened or closed.

8. The battery control module of claim 7, wherein said access lid is adapted to provide both environmental sealing and electrical shielding.

9. The battery control module of claim 1, wherein the cover is adapted to provide environmental sealing for said opening.

10. The battery control module of claim 1, wherein the cover is configured to provide electrical shielding for said housing.

11. The battery control module of claim 1, wherein the controller is configured to determine a terminal voltage of the battery cell.

12. The battery control module of claim 11, wherein the controller is configured to receive and interpret a plurality of digital signals indicative of the terminal voltage the battery cell.

13. The battery control module of claim 12, further including,
a third connector coupled to said controller and configured to connect to a vehicle communication bus, whereby said controller may transmit the plurality of digital signals.

14. A battery pack configured to interface with an electrical load and electrical source, said battery pack comprising:
a plurality of battery cells;
a housing configured to contain said plurality of battery cells, wherein said housing defines an access opening;
a battery control module disposed within said access opening, said battery control module including,
a cover,
a plurality of rigid conductors disposed on said cover,
a first connector disposed on an outer surface of the cover, coupled to said plurality of rigid conductors, and configured to connect to said electrical load,
a second connector coupled to said plurality of rigid conductors coupled to said first connector, and coupled to said plurality of battery cells,
a controller disposed on said cover, coupled to said plurality of rigid conductors and configured to control charging of said plurality of battery cells, and
a battery connection circuit disposed on said cover, coupled to said plurality of rigid conductors, and in communication with said controller, wherein said battery connection circuit is configured to establish or break an electrical connection between said plurality of battery cells and said electrical load in response to a signal from said controller.

15. The battery pack of claim 14, further including,
a battery voltage monitor configured to determine a terminal voltage of each battery cell in a portion of the plurality of battery cells, configured to transmit a plurality of digital signals indicative of the terminal voltage of each battery cell in the plurality of battery cells, and in communication with said controller, wherein said controller is configured to receive and interpret the plurality of digital signals.

16. The battery pack of claim 15, further including,
an intermodule connector configured to electrically couple a first terminal of a first battery cell in the plurality of battery cells to a second terminal of a second battery cell in the plurality of battery cells, wherein the intermodule connector is coupled to the battery voltage monitor; and
an intermodule connector holder configured to mechanically couple the intermodule connector to the first battery cell and the second battery cell, wherein the intermodule connector holder is configured to electrically isolate the intermodule connector from the first terminal and the second terminal until the intermodule connector is attached to the first terminal and the second terminal.
